(19) United States
(12) Patent Application Publication
(10) Pub. No.: US 2015/0029231 A1
(43) Pub. Date: Jan. 29, 2015

(54) METHOD AND SYSTEM FOR RENDERING A SLIDING OBJECT

(71) Applicants: Fu Tai Hua Industry (Shenzhen) Co., Ltd., Shenzhen (CN); HON HAI PRECISION INDUSTRY CO., LTD., New Taipei (TW)

(72) Inventors: YA-LING LIU, Shenzhen (CN); SHUANG HU, Shenzhen (CN); CHIH-SAN CHIANG, New Taipei (TW); HUA-DONG CHENG, Shenzhen (CN); HAI-SEN LIANG, Shenzhen (CN)

(21) Appl. No.: 14/338,759

(22) Filed: Jul. 23, 2014

(30) Foreign Application Priority Data
Jul. 25, 2013 (CN) 2013103138536

(51) Int. Cl. G06F 3/0484; G06F 3/0488

(52) U.S. Cl. CPC G06F 3/04845; G06F 3/04842; G06F 3/0488
USPC 345/681

(57) ABSTRACT

A method for displaying a virtual momentum or inertia of an object includes detecting a slide operation applied to the object and obtaining information of the slide operation. An initial speed, a first slide direction, and a sliding distance of the object are calculated according to the obtained information after a user ceases applying a slide operation to the object. A slide path of the object is determined according to the calculated initial speed, the calculated first slide direction, and the calculated sliding distance. The object is controlled to continue sliding, subject to an apparent friction and apparent collisions with edges of a display screen, along the determined slide path after the user ceases to apply an actual sliding operation.

### FIELD

The subject matter herein generally relates to display technologies, and particularly relates to a method and a system for controlling the display of a slide path of an object.

### BACKGROUND

Touch screens are provided on electronic devices for direct interaction with users. An icon displayed on the touch screen guides the user to slide the icon along an indicated path to unlock the touch screen or to run applications associated with the icon. Typically, the icon immediately stops sliding when the sliding by the users stops.

### BRIEF DESCRIPTION OF THE DRAWINGS

Implementations of the present technology will now be described, by way of example only, with reference to the attached figures.

FIG. 1 is a block diagram of one embodiment of a system for controlling to display slide path of a slid object and a hardware environment in which the system runs.

FIG. 2 is a diagrammatic view of an embodiment showing a slide path of a slid object, simulating the slide path of a slid object colliding with one edge of touch screen.

FIG. 3 is a diagrammatic view of another embodiment showing a slide path of a slid object, simulating the slide path of a slid object not colliding with edges of touch screen.

FIG. 4 is a flowchart of a method for controlling to display slide path of a slid object.

FIG. 5 is a sub-flowchart of block 302 of FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, and procedures components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The word “module,” and “unit” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

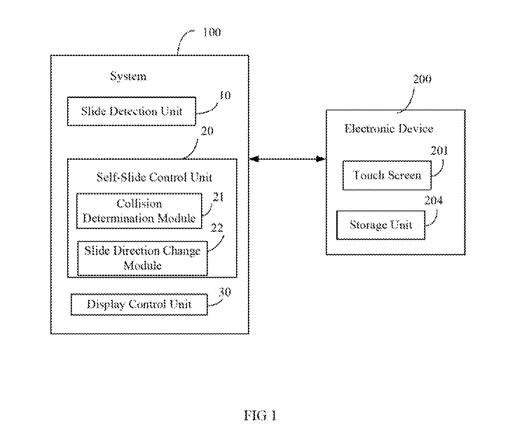

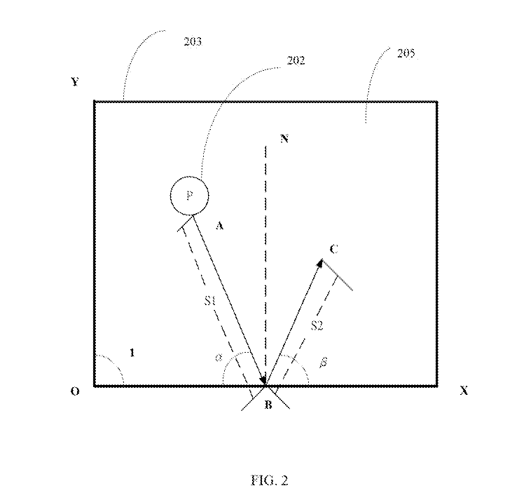

FIG. 1 illustrates a system 100 for controlling the apparent inertia or momentum of an object and its slide path. The system 100 can be installed and run on an electronic device 200, such as, a phone, a tablet computer, or the like. The electronic device 200 can include a touch screen 201 and a storage unit 204. The storage unit 204 can store objects 202 (shown in FIG. 2) such as characters, pictures, and icons that can be displayed on the touch screen 201. The object can be slid when a user applies a slide operation to it. As shown in FIG. 2, in at least one embodiment, the object 202 is an icon.

The system 100 can include a slide detection unit 10, a self-slide control unit 20, and a display control unit 30.

The slide detection unit 10 can detect a slide operation applied to the object 202 displayed on the touch screen 201 and obtain information of the slide operation. In at least one embodiment, the sliding information of the slide operation can include coordinates of starting point (X1, Y1) of the slide operation, coordinates of ending point (X2, Y2) of the slide operation, and duration T of the slide operation. The starting point of the slide operation is the point a user touches to begin dragging the object 202. The end point of the slide operation is the last point the user touches to stop the dragging of the object 202. The points (X1, Y1) are coordinates of the starting point of a slide operation. The points (X2, Y2) are coordinates of the end point of a slide operation. The period T is the duration of time in which a user drags the object 202 from the starting point to the end point.

In one embodiment, a coordinate system defining the initial and end points is based on the size of display area 205 (show in FIG. 2) of the touch screen 201. For example, one of the four vertexes of the display area 205 is an origin point 0 (0, 0) of the coordinate system, such as left bottom vertex 1 shown in FIG. 2. One of two adjacent lines vertically passing through the origin point 0 (0, 0) is an X-axis of the coordinate system, and another line vertically passing through the origin point 0 (0, 0) is a Y-axis of the coordinate system. So, each location on the display area 205 of the touch screen 201 is associated with points (X, Y) of the coordinates system, that is to say, a location of the display area 205 can be expressed by associated points (X, Y) of the coordinates system.

The self-slide control unit 20 can calculate an initial speed, a first slide direction, and a slide distance of the object 202 according to the obtained information of the slide operation after the slide operation applied to the slid object ceases. The self-slide control unit 20 can determine a slide path of the object 202 according to the calculated initial speed, the calculated first slide direction, and the calculated sliding distance. The self-slide control unit 20 also controls the slid object 202 to slide along the determined slide path. The object 202 continues to slide at a decreasing speed after the slide operation applied to the object 202 by the user is stopped.

In at least one embodiment, when the slide operation applied to the object 202 ceases, the self-slide control unit 20 calculates the initial speed according to a formula V=2\sqrt{(Y2−Y1)²+(X2−X1)²}/T. The self-slide control unit 20 calculates the first direction according to a formula

$$D = arctan \frac{Y 2 - Y 1}{X 2 - X 1} .$$

The self-slide control unit 20 calculates the distance according to a formula

$$S = \frac{2 [ {( Y 2 - Y 1 )}^{2} + {( X 2 - X 1 )}^{2} ]}{{UT}^{2}} .$$

The parameter U is a friction coefficient which affects the self sliding of the slid object. The magnitude of the parameter U can be preset by a user.

The display control unit 30 can control the display of the slide path of the object 202 on the touch screen 201 after the slide operation applied to the object 202 stops. Specifically, the display control unit 30 controls the display of the apparent sliding at different location points of the display area 205 associated with different time points after the user stops applying a slide operation to the object 202.

In an alternative embodiment, the self-slide control unit 20 can include a collision determination module 21 and a slide direction change module 22.

The collision determination module 21 can determine whether the object 202 collides with the edge 203 of the touch screen 201 during the self sliding process of the object 202. If the distance from the end point of the touching to an edge of the touch screen 201 along the first direction is S1, and S1<S, the distance S is calculated according to the formula

$$\frac{2 [ {( Y 2 - Y 1 )}^{2} + {( X 2 - X 1 )}^{2} ]}{{UT}^{2}} ,$$

and the collision determination module 21 determines that the object 202 collides with the edge 203 of the touch screen 201 during the self sliding process. When S1>S or S1=S, the collision determination module 21 determines that the object 202 finishes the self sliding to stop along the first direction before colliding with the edge 203 of the touch screen 201.

When the object 202 does collide with the edge 203 of the touch screen 201, the slide direction change module 22 can change the first slide direction to a second slide direction, and then the object 202 continues to slide along the second slide direction. The second slide direction is determined according to the angle between a line along the first slide direction and the line represented by the edge 203, with which the object 202 collides, of the touch screen 201.

FIG. 2 illustrates an example of the self-sliding process of an object 202 after a slide operation applied to the object 202 is stopped. In the embodiment, the object 202 is a circle icon P in FIG. 2. When a slide operation applied to the icon P is stopped at point A, for example, a user drags the icon P to slide and then releases the icon P at point A, the icon P then continues sliding in the first direction AB. In this embodiment, the line AB connects with the edge 203 of the touch screen 201 at point B along the first direction AB. The distance from the end point A to the edge 203 of the touch screen 201 along the first direction AB is S1, and S1<S, the S being calculated according to the formula

$$\frac{2 [ {( Y 2 - Y 1 )}^{2} + {( X 2 - X 1 )}^{2} ]}{{UT}^{2}} .$$

In this case, the collision determination module 21 determines that the icon P collides at point B with the edge 203 of the touch screen 201 in the self slide process in the first direction AB. Then, the slide direction change module 22 changes the first slide direction AB of the icon P to a second slide direction BC, and the icon P self slides along the second direction BC. The distance which the icon P slides along the second direction BC is S2, and S1+S2=S. The angle between the first direction AB and the edge 203 of the touch screen 201 is α, the angle between the second direction BC and the edge 203 of the touch screen 201 is β, and α=β. At same time, the display control unit 30 controls the display of the slide path of the icon P along the direction AB and the display of the slide path of the icon P along the direction BC.

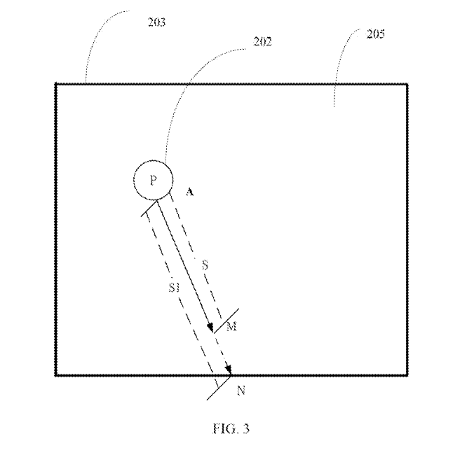

FIG. 3 illustrates another example of the self-slide process of an object 202 after a slide operation applied to the object 202 is stopped. In this embodiment, when a user drags the icon P to slide and releases the icon P at point A, the icon P then continues to slide itself along the first direction AM and stops at point M. The distance from the point A to point M is S, the S is calculated according to the formula

$$\frac{2 [ {( Y 2 - Y 1 )}^{2} + {( X 2 - X 1 )}^{2} ]}{{UT}^{2}} .$$

The line AM strikes the edge of the touch screen 201 at point N along the first direction AM. The distance from the point A to point N is S1, and S1>S. In this case, the collision determination module 21 determines that the object 202 does not collide with the edge of the touch screen 201 during the process of self-slide of the object 202.

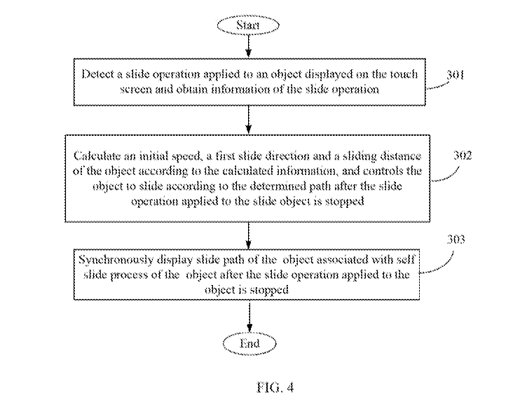

Referring to FIG. 4, a flowchart of a method for controlling the display of a slide path of a slid object is presented in accordance with an example embodiment. The example method is provided by way of example, as there are a variety of ways to carry out the method. The method described below can be carried out using the configurations illustrated in FIG. 1, for example, and various elements of these figures are referenced in explaining the example method. Each block shown in FIG. 3 represents one or more processes, methods, or subroutines, carried out in the exemplary method. Additionally, the illustrated order of blocks is by example only and the order of the blocks can change. The exemplary method can begin at block 301.

At block 301, the slide detection unit detects a user applying a slide operation to an object displayed on the touch screen and obtains information of the slide operation.

In at least one embodiment, the information of the slide operation can include coordinates of starting point (X1, Y1), coordinates of end point (X2, Y2) of the slide operation, and time duration T of the slide operation.

At block 302, the self-slide control unit calculates an initial speed, a first slide direction, and a slide distance of the object according to the obtained information after the slide operation applied to the object is stopped. A slide path of the object is determined according to the calculated initial speed, the calculated first slide direction, and the calculated slide distance, and the object is controlled to slide itself following the determined slide path after the user ceases applying a slide operation to the object.

In at least one embodiment, when the slide operation applied to the object is stopped, the self-slide control unit calculates the initial speed according to a formula V=2\sqrt{(Y2−Y1)²+(X2−X1)²}/T, calculates the first direction according to a formula

$$D = arctan \frac{Y 2 - Y 1}{X 2 - X 1} ,$$

and calculates the distance according to a formula

$$S = \frac{2 [ {( Y 2 - Y 1 )}^{2} + {( X 2 - X 1 )}^{2} ]}{{UT}^{2}} .$$

The points (X1, Y1) are coordinates of the starting point of a slide operation. The points (X2, Y2) are coordinates of ending point of a slide operation. The period T is a time duration for which a user drags the object 202 from the starting point to the ending point. The parameter U is a friction coefficient which affects the self slide of the object.

At block 303, the display control unit controls the display of the slide path of the object after the slide operation applied to the object by a user is stopped.

In at least one embodiment, the display control unit controls the display of the object at different locations of the display area of the touch screen associated with different time points after the slide operation applied to the object by a user is stopped.

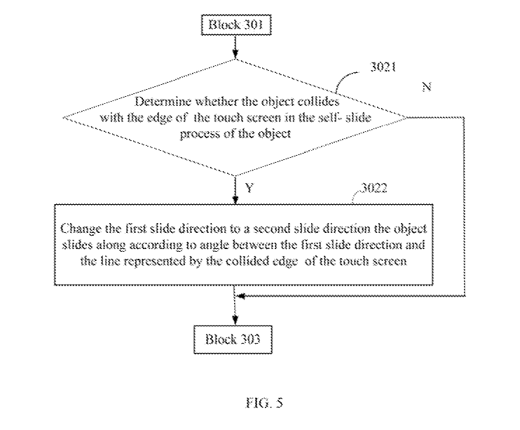

FIG. 5 illustrates a sub-flowchart of the block 302 in FIG. 4.

At block 3021, the collision determination module determines whether the object collides with the edge of the touch screen during the process of self-slide of the object; if yes, the process goes to block 3022; otherwise, the process goes to block 303.

In at least one embodiment, if the distance S1 from the ending point of the touching to an edge of the touch screen along the first direction is less than the distance S, the distance S being calculated according to the formula

$$\frac{2 [ {( Y 2 - Y 1 )}^{2} + {( X 2 - X 1 )}^{2} ]}{{UT}^{2}} ,$$

the collision determination module determines that the object collides with the edge of the touch screen during the self sliding process.

At block 3022, the slide direction change module changes the first slide direction to a second slide direction according to the angle between the first slide direction and a line represented by the edge of the touch screen. The angle between the first slide direction and the edge of the touch screen struck by the first slide direction equals the angle between the second slide direction and the collided edge of the touch screen.

The embodiments shown and described above are only examples. Many details are often found in the art such as the other features of an electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A method of rendering a sliding object, the method comprising:
detecting a slide operation applied to an object displayed on a touch screen of an electronic device;
obtaining information of the slide operation;
calculating an initial speed, a first slide direction and a sliding distance of the object in accordance with the obtained information;
determining a slide path of the object according to the calculated initial speed, first slide direction, and sliding distance; and
controlling the object to slide along the determined slide path after the slide operation applied to the object is stopped.

2. The method as claimed in claim 1, further comprising:
synchronously displaying the slide path of the slid object associated with a self slide process of the object after the slide operation applied to the object is stopped.

3. The method as claimed in claim 2, wherein the information of the slide operation comprises coordinates of a starting point (X1, Y1), coordinates of an ending point (X2, Y2) of the slide operation, and duration time T of the slide operation.

4. The method as claimed in claim 3, wherein the initial speed is calculated according to a formula V=2\sqrt{(Y2−Y1)²+(X2−X1)²}/T, the first direction is calculated according to a formula
$$D = arctan \frac{Y 2 - Y 1}{X 2 - X 1} ,$$
the distance is calculated according to a formula
$$S = \frac{2 [ {( Y 2 - Y 1 )}^{2} + {( X 2 - X 1 )}^{2} ]}{{UT}^{2}} ,$$
and the parameter U is a preset friction coefficient affecting the slide process of the object.

5. The method as claimed in claim 4, further comprising:
determining whether the object collides with an edge of the touch screen during the self sliding process of the object; and
changing the first slide direction to a second slide direction the object slides along according to angle between the first slide direction and the line represented by the collided edge of the touch screen when the object collides with the edge of the touch screen.

6. The method as claimed in claim 4, further comprising determining whether the object collides with the edge of the touch screen during the self sliding processing of the slid object when the distance from the ending point to the edge of the touch screen along the first slide direction is less than the distance being calculated according to the formula
$$S = \frac{2 [ {( Y 2 - Y 1 )}^{2} + {( X 2 - X 1 )}^{2} ]}{{UT}^{2}} ;$$
changing the first slide direction to a second slide direction the object slides along according to angle between the first slide direction and the line represented by the collided edge of the touch screen when the object collides with the edge of the touch screen.

7. A system for rendering a sliding object, the system comprising:
a slide detection unit configured for detecting a slide operation applied to an object displayed on a touch screen of an electronic device, and obtaining information of the slide operation;
a self-slide control unit configured for calculating an initial speed, a first slide direction, and a sliding distance of the object in accordance with the obtained information, determining a slide path of the object according to the calculated initial speed, first slide direction and sliding distance, and controlling the object to slide along the determined slide path after the slide operation applied to the object is stopped.

8. The system as claimed in claim 7, further comprising:
a display control unit configured for synchronously displaying the slide path of the object associated with a slide process of the object after the self slide operation applied to the object is stopped.

9. The system as claimed in claim 8, wherein the information of the slide operation comprises coordinates of a starting point (X1, Y1), coordinates of an ending point (X2, Y2) of the slide operation, and duration time T of the slide operation.

10. The system as claimed in claim 9, wherein the initial speed is calculated according to a formula V=2\sqrt{(Y2−Y1)²+(X2−X1)²}/T, the first direction is calculated according to a formula
$$D = arctan \frac{Y 2 - Y 1}{X 2 - X 1} ,$$
the distance is calculated according to a formula
$$S = \frac{2 [ {( Y 2 - Y 1 )}^{2} + {( X 2 - X 1 )}^{2} ]}{{UT}^{2}} ,$$
and the parameter U is a preset friction coefficient affecting the slide process of the object.

11. The system as claimed in claim 9, wherein the self-slide control unit further comprises:
a collision determination module configured for determining whether the object collides with an edge of the touch screen;
a slide direction change module configured for changing the first slide direction to a second slide direction the object slides along according to an angle between the first slide direction and the line representing by the collided edge of the touch screen when the object collides with the edge of the touch screen.

12. The system as claimed in claim 11, wherein the angle between the first slide direction and the line represented by the collided edge of the touch screen equals an angle between the second slide direction and the line represented by the collided edge of the touch screen.

13. An electronic device for rendering a sliding object comprising:
a touch screen displaying an object; and
a system comprising:
a detection unit configured for detecting a slide operation applied to the object and obtaining information of the slide operation;
a self-slide control unit configured for calculating an initial speed, a first slide direction, and a sliding distance of the object in accordance with the obtained information, determining a slide path of the object according to the calculated initial speed, first slide direction, and sliding distance, and controlling the object to slide along the determined slide path after the slide operation applied to the object is stopped;
a display control unit configured for synchronously displaying the slide path of the object associated with the slide process of the object after the slide operation applied to the object is stopped.

14. The electronic device as claimed in claim 13, wherein the information of the slide operation comprises coordinates of a starting point (X1, Y1), coordinates of an ending point (X2, Y2) of the slide operation, and duration time T of the slide operation.

15. The electronic device as claimed in claim 14, wherein the initial speed is calculated according to a formula V=2\sqrt{(Y2−Y1)²+(X2−X1)²}/T, the first direction is calculated according to a formula
$$D = arctan \frac{Y 2 - Y 1}{X 2 - X 1} ,$$
the distance is calculated according to a formula
$$S = \frac{2 [ {( Y 2 - Y 1 )}^{2} + {( X 2 - X 1 )}^{2} ]}{{UT}^{2}} ,$$
the parameter U is a preset friction coefficient affecting the self-slide process of the object.

16. The electronic device as claimed in claim 15, wherein the self-slide control unit further comprises:
a collision determination module configured for determining whether the object collides with the edge of the touch screen;
a slide direction change module configured for changing the first slide direction to a second slide direction the object slides along according to an angle between the first slide direction and the line represented by the collided edge of the touch screen when the object collides with the edge of the touch screen.

17. The electronic device as claimed in claim 16, wherein the angle between the first slide direction and the line represented by the collided edge of the touch screen equals an angle between the second slide direction and the line represented the collided edge of the touch screen.
